(19) United States
(12) Patent Application Publication
(10) Pub. No.: US 2021/0302079 A1
(43) Pub. Date: Sep. 30, 2021

(54) FLUID CONDUIT CONNECTION OF AN HVAC SYSTEM

(71) Applicant: Carrier Corporation, Palm Beach Gardens, FL (US)

(72) Inventors: Thomas Bryant, Brewerton, NY (US); Robert A. Leffler, Boston, MA (US); Luis F. Avila, Manlius, NY (US); Duane V. Douglas, Indianapolis, IN (US)

(21) Appl. No.: 17/301,033

(22) Filed: Mar. 23, 2021

Related U.S. Application Data
(60) Provisional application No. 62/994,565, filed on Mar. 25, 2020.

(51) Int. Cl. F25B 41/40; F16L 13/11

(52) U.S. Cl. CPC F25B 41/40; F16L 13/116

(57) ABSTRACT

Disclosed is a fluid conduit connection of a vapor compression system having a cooling capacity of less than or equal to 60,000 Btu/hour comprising a first fluid conduit comprising a first aluminum alloy and having first fluid conduit outside hydraulic diameter of greater than or equal to 7 millimeters, a second fluid conduit comprising a second aluminum alloy, a second fluid conduit cross-sectional flow area, and having a second fluid conduit outside hydraulic diameter of less than or equal to 7 millimeters, an engagement between the first fluid conduit and the second fluid conduit, and a sealing material disposed within the engagement serving to mechanically bind and seal the fluid conduit connection, wherein a ratio of a cross sectional flow area of a throat of the fluid conduit connection divided by the second fluid conduit cross-sectional flow area is between 0.1 and 0.6.

### CROSS REFERENCE TO A RELATED APPLICATION

The application claims the benefit of U.S. Provisional Application No. 62/994,565 filed Mar. 25, 2020, the contents of which are hereby incorporated in their entirety.

### BACKGROUND

Exemplary embodiments pertain to the art of heating, ventilation and air conditioning systems (HVAC). More particularly, the present disclosure relates to configurations of plumbing connections in HVAC systems.

As the cost of copper remains high HVAC systems manufacturers are incented to develop products using alternative materials that can reduce product cost. One area where material substitution has helped to reduce dependence on copper is in the manufacture of heat exchangers. As performance, strength, and material compatibility of aluminum heat exchangers become in line with HVAC system requirements it is likely that their use will become widespread in HVAC systems. A challenge to the HVAC system integrator can become fluidly coupling the HVAC components in an optimal way, e.g., in a way to maximize system efficiency. Accordingly, there remains a need in the art for fluid couplings that can minimize system impact.

### BRIEF DESCRIPTION

Disclosed is a fluid conduit connection of a vapor compression system having a cooling capacity of less than or equal to 60,000 Btu/hour comprising: a first fluid conduit comprising a first aluminum alloy and having first fluid conduit outside hydraulic diameter of greater than or equal to 7 millimeters, a second fluid conduit comprising a second aluminum alloy, a second fluid conduit cross-sectional flow area, and having a second fluid conduit outside hydraulic diameter of less than or equal to 7 millimeters, an engagement between the first fluid conduit and the second fluid conduit, and a sealing material disposed within the engagement serving to mechanically bind and seal the fluid conduit connection, wherein a ratio of a cross sectional flow area of a throat of the fluid conduit connection divided by the second fluid conduit cross-sectional flow area is between 0.1 and 0.6.

In addition to one or more of the above disclosed aspects or as an alternate further comprising a coupling having a first inner surface disposed on a first end and a second inner surface disposed on second end, wherein the first fluid conduit is inserted a first insertion distance of between 1.3 and 12.5 times an outside hydraulic diameter of the second fluid conduit into the first end of the coupling and the second fluid conduit is inserted a second insertion distance of between 1.3 and 12.5 times the outside hydraulic diameter of the second fluid conduit into the second end of the coupling, and wherein the engagement comprises a first inner surface of the coupling and an outer surface of the first fluid conduit and a second inner surface of the coupling and an outer surface of the second fluid conduit.

In addition to one or more of the above disclosed aspects or as an alternate wherein the first insertion distance of the first fluid conduit into the coupling is between 8 and 12 times the outside hydraulic diameter of the second fluid conduit.

In addition to one or more of the above disclosed aspects or as an alternate wherein the second insertion distance of the second fluid conduit into the coupling is between 8 and 12 times the outside hydraulic diameter of the second fluid conduit.

In addition to one or more of the above disclosed aspects or as an alternate wherein a ratio of the first insertion distance divided by an inside hydraulic diameter of the second fluid conduit is between 4.0 and 4.6.

In addition to one or more of the above disclosed aspects or as an alternate wherein a ratio of the second insertion distance divided by an inside hydraulic diameter of the second fluid conduit is between 4.0 and 4.6.

In addition to one or more of the above disclosed aspects or as an alternate wherein the first fluid conduit, the second fluid conduit, and the coupling each comprise a substantially round transverse cross-sectional shape.

In addition to one or more of the above disclosed aspects or as an alternate wherein the first fluid conduit further comprises a neck disposed on one end having a neck length, wherein the second fluid conduit further comprises a belled section disposed on one end, and wherein the neck is inserted an insertion distance of between 1.3 and 12.5 times the outside hydraulic diameter of the second fluid conduit past the belled section, and wherein the engagement comprises an outer surface of the first fluid conduit disposed along a non-necked portion of the first fluid conduit and adjacent to the neck of the first fluid conduit and an inner surface of the second fluid conduit along the belled section.

In addition to one or more of the above disclosed aspects or as an alternate wherein the neck length of the first fluid conduit is between 8 and 12 times the outside hydraulic diameter of the second fluid conduit.

In addition to one or more of the above disclosed aspects or as an alternate wherein a ratio of the neck length divided by an inside hydraulic diameter of the second fluid conduit is between 4.0 and 4.6.

In addition to one or more of the above disclosed aspects or as an alternate wherein the second fluid conduit is an inlet conduit of a an evaporator of the vapor compression system, and wherein the evaporator is a round tube heat exchanger and the second fluid conduit passes through a finned core section of the evaporator.

In addition to one or more of the above disclosed aspects or as an alternate wherein the first fluid conduit is an outlet conduit of an evaporator inlet distributor.

In addition to one or more of the above disclosed aspects or as an alternate wherein the first fluid conduit comprises a conduit formed from a rolling and welded process and the second fluid conduit comprises a conduit formed from an extrusion process.

In addition to one or more of the above disclosed aspects or as an alternate wherein the first fluid conduit and second fluid conduits each comprise a substantially round transverse cross-sectional shape.

In addition to one or more of the above disclosed aspects or as an alternate wherein a ratio of a cross sectional flow area of the throat of the fluid conduit connection divided by the second fluid conduit cross-sectional flow area is between 0.2 and 0.5.

Further discloses is a vapor compression system having a cooling capacity of less than or equal to 60,000 Btu/hour comprising: an evaporator comprising an evaporator inlet conduit, a fluid distributor comprising a distributor outlet conduit, and a fluid conduit connection of one or more of the above disclosed aspects coupling the evaporator inlet conduit to the distributor outlet conduit.

In addition to one or more of the above disclosed aspects or as an alternate wherein the evaporator inlet conduit is formed in a rolling and welding process and the distributor outlet conduit is formed in an extrusion process.

Further discloses is a method of forming a fluid conduit connection of a vapor compression system having a cooling capacity of less than or equal to 60,000 Btu/hour comprising: engaging a first fluid conduit and a second fluid conduit to form the fluid conduit connection, and applying a sealing material between an outer surface of the first fluid conduit and an inner surface of a second fluid conduit or an inner surface of a coupling to mechanically bond and fluidically seal the fluid conduit connection.

### BRIEF DESCRIPTION OF THE DRAWINGS

The following descriptions should not be considered limiting in any way. With reference to the accompanying drawings, like elements are numbered alike:

FIG. 1 is a schematic illustration of a vapor compression system.

FIG. 2 is a schematic illustration of an axial cross-section of a fluid conduit connection of a vapor compression system.

FIG. 3 is a schematic illustration of an axial cross-section of a fluid conduit connection of a vapor compression system.

FIG. 4 is a schematic illustration of an axial cross-section of a fluid conduit connection of a vapor compression system having a coupling.

FIG. 5 is a schematic illustration of the transverse cross section A-A of the fluid conduit connection of FIGS. 2-3.

FIG. 6 is a schematic illustration of the transverse cross section A-A of the fluid conduit connection of FIGS. 2-3.

FIG. 7 is a schematic illustration of the transverse cross section A-A of the fluid conduit connection of FIGS. 2-3.

FIG. 8 is a schematic illustration of the transverse cross section A-A of the fluid conduit connection of FIG. 4.

FIG. 9 is a schematic illustration of the transverse cross section A-A of the fluid conduit connection of FIG. 4.

FIG. 10 is a schematic illustration of the transverse cross section A-A of the fluid conduit connection of FIG. 4.

### DETAILED DESCRIPTION

A detailed description of one or more embodiments of the disclosed apparatus and method are presented herein by way of exemplification and not limitation with reference to the Figures.

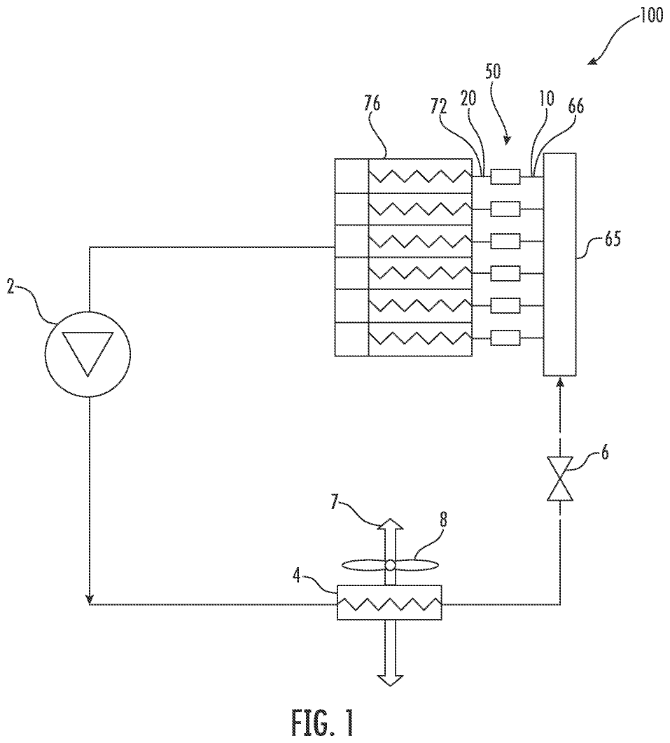

FIG. 1 is a schematic illustration of a vapor compression system 100 having a fluid conduit connection 50 disposed therein. The vapor compression system 100 can include a compressor 2, a condenser 7, and expansion device 6, and evaporator 7, and interconnecting plumbing configured in a fluid loop. The compressor 2 can pressurize a refrigerant stream exiting the compressor 2 as it is pushed to a condenser 4. In the condenser 4 the hot, gas phase, refrigerant is cooled via heat exchange with a separate heat transfer fluid flow 7 (e.g., air pushed, or pulled, through the condenser 4 by a fan 8). The cooled, pressurized refrigerant is then expanded as it passes through an expansion device 6 before entering an evaporator 76. The vapor compression system 100 can further include a fluid distributor 65 disposed in fluid communication with one or more inlet conduits 72 of the evaporator 76. The vapor compression system 100 can have a rated cooling capacity (e.g., designed maximum steady state operating thermal output rate, advertised cooling capability) of about 6 tons (72,000 Btu/hr) or less. For example, the vapor compression system 100 can have a rated cooling capacity of about 6 tons (72,000 Btu/hr), about 5.5 tons (66,000 Btu/hr), about 5 tons (60,000 Btu/hr), about 4.5 tons (54,000 Btu/hr), about 4 tons (48,000 Btu/hr), about 3.5 tons (42,000 Btu/hr), about 3 tons (36,000 Btu/hr), about 2.5 tons (30,000 Btu/hr), about 2 tons (24,000 Btu/hr), about 1.5 tons (18,000 Btu/hr), or about 1 ton (12,000 Btu/hr). The inventors have found that for systems that have a rated cooling capacity of 6 tons or less, significant performance reductions can be attributed to pressure drop in the interconnecting plumbing and in particular at the interconnection between dissimilar fluid conduits (e.g., as fluid conduit sizes are scaled down with the rated cooling capacity). Accordingly, the fluid conduit connection 50 can be used to connect dissimilar conduits (e.g., conduits having different outside diameters, wall thicknesses, and the like) of the vapor compression system 100. One point in the vapor compression system 100 where dissimilar conduits meet can be at a heat exchanger interface. For example, the fluid conduit connection 50 described herein can be used to fluidly couple an outlet conduit 66 of a fluid distributor 65 to an inlet conduit 72 of an evaporator 76.

For example, a first fluid conduit 10 can extend between a fluid distributor 65 and an evaporator 76 and can be coupled to a second fluid conduit 20 acting as an inlet to the evaporator 76 (e.g., hairpin line). The first fluid conduit 10 can include extruded conduit (e.g., having relatively thicker walls). The second fluid conduit 20 can be formed with relatively thin walls (e.g., in a rolling and welding process).

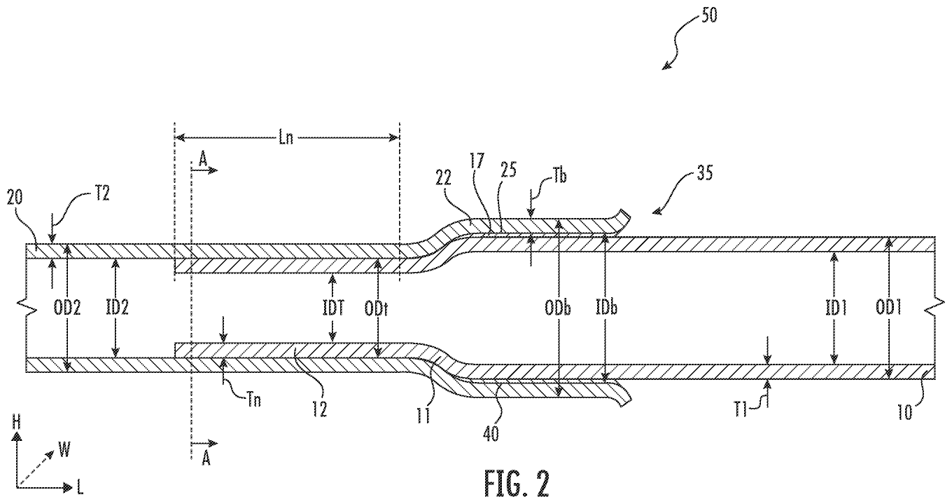

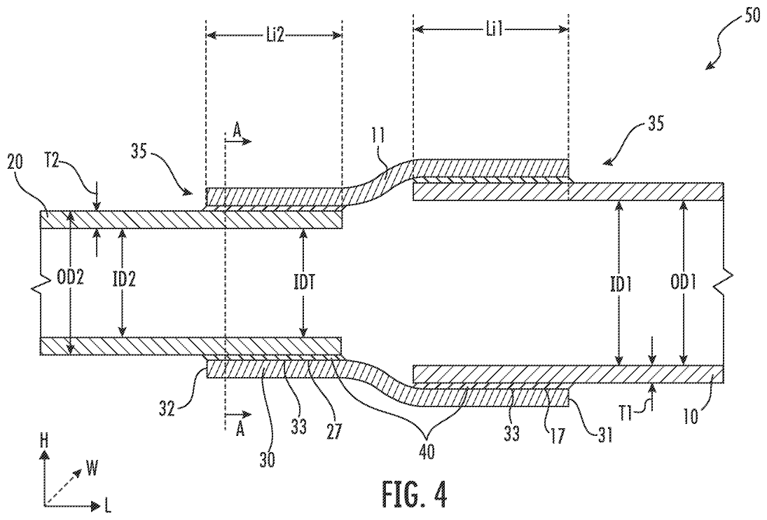

FIGS. 2-4 are schematic illustrations of an axial cross-section of fluid conduit connection 50 of a vapor compression system 100. The fluid conduit connection 50 can include a first fluid conduit 10 including a first aluminum alloy and a second fluid conduit 20 including a second aluminum alloy. The first fluid conduit 10 can have a first fluid conduit outside hydraulic diameter of greater than or equal to 7 millimeters (mm) (e.g., 7 mm, 5/16 inch, 8 mm, 9 mm, ⅜ inch, and the like). The second fluid conduit 20 can have a second fluid conduit outside hydraulic diameter of less than or equal to 7 mm (e.g., 7 mm, ¼ inch, 5 mm, 3/16 inch and the like). The fluid conduit connection 50 can include an engagement 35 between the first fluid conduit 10 and the second fluid conduit 20. The engagement can include a sealing material 40 disposed therein which can serve to mechanically bind and seal the fluid conduit connection 50.

The first fluid conduit 10 can include a neck 12 disposed on one end. The neck 12 can include a neck cross-sectional flow area (e.g., extending in the w-h plane of the attached figures) and a neck length Ln (e.g., extending along the 1-axis in the attached figures). The second fluid conduit 20 can include a second fluid conduit cross-sectional flow area and a belled section 22. The first fluid conduit 10 can be inserted into the second fluid conduit 20. For example, the neck 12 can be inserted into the second fluid conduit 20 such that the first fluid conduit 10 is engaged with the second fluid conduit 20 at the engagement 35. In an example, the neck 12 can extend substantially past the belled section 22.

The fluid conduit connection 50 can include a coupling 30 including a third aluminum alloy and having a first end 31 and a second end 32. In an example, the first end 31 and the second end 32 can be opposing ends of the coupling 30. The first fluid conduit 10 can be inserted a first insertion distance Li1 into the first end 31 of the coupling 30 and the second fluid conduit 20 can be inserted a second insertion distance Li2 into the second end 32 of the coupling 30 to form the engagement 35.

The inventors have found that extending the neck 12 of the first fluid conduit 10 into the second fluid conduit 20 a distance Ln and/or extending the first fluid conduit 10 and the second fluid conduit 20 into the coupling 30 a distance of Li1 and Li2 respectively, can create an overlapped section of the engagement 35 which can provide additional strength to the fluid conduit connection 50 which can aid in preventing damage from mechanical shock and vibrational loads (e.g., due to shipping and handling, installation, operation, and the like). Accordingly, the neck length Ln, the first insertion distance Li1, or the second insertion distance Li2 can each individually be equal to from about 1.2 to about 15 times, or from about 1.3 to about 12.5 times, or from 8 to about 12 times the outside hydraulic diameter of the second fluid conduit (e.g., where the hydraulic diameter can be equal to four times the cross-sectional area of a the conduit divided by its perimeter). In an example, the first fluid conduit 10 and the second fluid conduit 20 each have a circular transverse cross-section and the neck length Ln of the first fluid conduit 10 is equal to from about 1.3 to about 12.5 times the outside diameter of the second fluid conduit OD2. In an example, the first fluid conduit 10, the second fluid conduit 20, and the coupling 30 each have a circular cross-sectional flow area and the first insertion distance Li1 of first fluid conduit 10 into the coupling 30 and the second insertion distance Li2 of second fluid conduit 20 into the coupling 30 are each equal to from about 1.3 to about 12.5 times the outside diameter of the second fluid conduit OD2. In an example, the first fluid conduit 10 and the second fluid conduit 20 each have a circular transverse cross-section and the neck length Ln of the first fluid conduit 10 is equal to from about 8 to about 12 times the outside diameter of the second fluid conduit OD2. In an example, the first fluid conduit 10, the second fluid conduit 20, and the coupling 30 each have a circular cross-sectional flow area and the first insertion distance Li1 of first fluid conduit 10 into the coupling 30 and the second insertion distance Li2 of second fluid conduit 20 into the coupling 30 are each equal to from about 8 to about 12 times the outside diameter of the second fluid conduit OD2. In an example, the second fluid conduit 20 has a circular transverse cross-section and has an outside diameter OD2 of about 5 mm and the overlapping distance of the engagement 35 is between 2.5 and 12.5 times the OD2. In an example, the second fluid conduit 20 a circular transverse cross-section and has an outside diameter OD2 of about 7 mm and the overlapping distance of the engagement 35 is between 1.7 and 9.0 times the OD2. In an example, the second fluid conduit 20 a circular transverse cross-section and has an outside diameter OD2 of about 5/16 inches and the overlapping distance of the engagement 35 is between 1.6 and 8 times the OD2. In an example, the second fluid conduit 20 a circular transverse cross-section and has an outside diameter OD2 of about ⅜ inches and the overlapping distance of the engagement 35 is between 1.3 and 6.7 times the OD2.

Further, the inventors have found that these structural benefits can be imparted on the fluid conduit connection 50 from a relationship between the overlapped distance (e.g., distance of the overlapped section of the engagement 35 along the 1-axis dimension in the attached figures) and the second fluid conduit inside hydraulic diameter (e.g., the hydraulic diameter associated with the inside surface of the second fluid conduit 20). In particular, each of the neck length Ln, the first insertion distance Li1, or the second insertion distance Lit divided by the second fluid conduit inside hydraulic diameter can be from about 3.5 to about 5.1, or from about 3.6 to about 5.0 or from about 3.7 to about 4.9, or from about 3.8 to about 4.8, or from about 3.9 to about 4.7, or from about 4.0 to about 4.6, or about 4.1 to about 4.5, or from about 4.2 to about 4.4.

The engagement 35 can include a sealing material 40 which can be disposed between two adjacent surfaces. For example, a sealing material 40 can be disposed between an outer surface 17 of the first fluid conduit 10 and an inner surface 25 of the second fluid conduit 20, between the outer surface 17 of the first fluid conduit 10 and an inner surface 33 of the coupling 30, between the outer surface 27 of the second fluid conduit and the inner surface 33 of the coupling 30, or a combination including at least one of the foregoing.

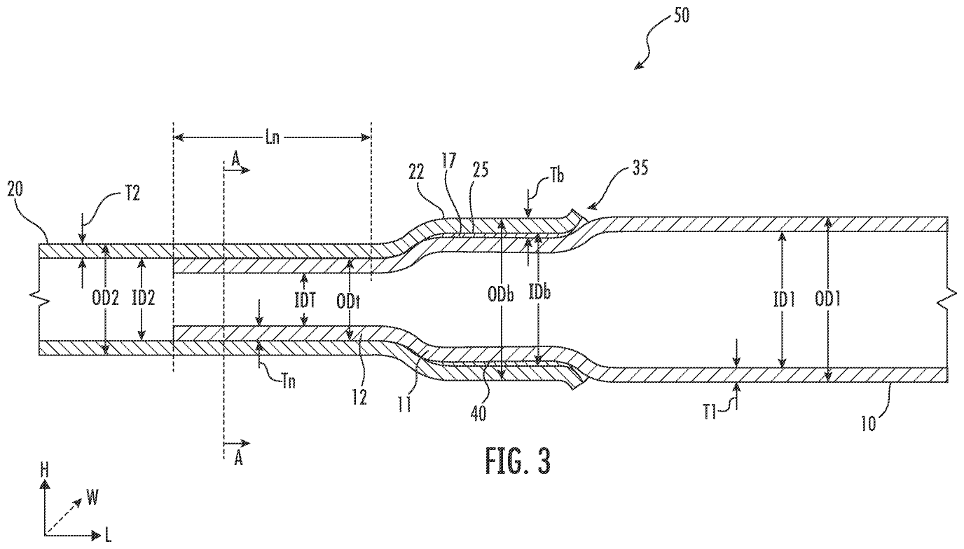

The sealing material 40 can include any suitable sealing and mechanically bonding material capable of preventing leakage during operation. For example, the sealing material 40 can include a thermoset polymer (e.g., epoxy), a braze material such as a fourth aluminum alloy, or the like and can serve to mechanically bind and seal the fluid conduit connection 50. The first fluid conduit 10, the second fluid conduit 20, the coupling 30, or a combination including at least one of the foregoing can include a transitional section 11 where the cross-sectional flow area is transitioned from a nominal cross-sectional flow area of the first fluid conduit 10 (e.g., at ID1 in the attached figures) to the nominal cross-sectional flow area of a throat section (e.g., at IDt or the location of smallest inside hydraulic diameter, smallest flow area of the fluid conduit connection 50). The transitional section 11 can include one or more reduced flow area sections (e.g., swaged, or necked down sections) or can result from a change in internal flow area of the first fluid conduit 10 to the second fluid conduit 20. In an example, the transitional section 11 can include a multi-stepped, internal flow area reduction such as shown in FIG. 3.

The first fluid conduit 10, the second fluid conduit 20, the coupling 30, or a combination thereof can be configured such that they have corresponding shapes. For example, the shape of the outer surface 17 of the first fluid conduit 10 can correspond to the shape of the inner surface 25 of the second fluid conduit 20. In an example, the shape of the outer surface 17 of the first fluid conduit 10 and/or outer surface 27 of the second fluid conduit 20 can be configured to correspond to the shape of the inner surface 33 of the coupling 30.

The cross-sectional shape of any of the first fluid conduit 10, the neck 12, the second fluid conduit 20, the belled section 22, or the coupling 30 can include any suitable shape, such as circular, oval, ovoid, triangular, quadrilateral (e.g., trapezoidal, square, rectangular, and the like), star shaped, the shape of a simple polygon having straight or curved sides, or the like. Accordingly, the cross-sectional flow area and the hydraulic diameter can be determined for any chosen cross-sectional shape of these elements of the fluid conduit connection 50. The first fluid conduit 10 can have a circular cross sectional shape having a nominal outside diameter of 7 millimeters (mm) or more and the second fluid conduit 20 can have a circular cross sectional shape having a nominal outside diameter of 7 millimeters (mm) or less.

In an example, the first fluid conduit 10, the neck 12, the second fluid conduit 20, and the belled section 22 can all have a circular cross-sectional shape. In this way the first fluid conduit 10 can further include a nominal inside diameter ID1, a nominal outside diameter OD1, and a nominal wall thickness T1, the second fluid conduit 20 can further include a nominal inside diameter ID2, a nominal outside diameter OD2, and a nominal wall thickness T2. The inside diameter ID1 and outside diameter OD1 of the first conduit 10 can be reduced from their nominal values to a throat inside diameter IDt and a throat outside diameter ODt after the transition 11 using a swaging or necking process. The second fluid conduit 20 can include a belled section 22 where the inside diameter ID2 and outside diameter OD2 of the second fluid conduit 20 can increase from their nominal values to an inside diameter at the bell IDb and an outside diameter at the bell ODb and a material thickness along the bell of Tb. The neck 12 of the first fluid conduit 10 can fit through the belled section 22 and into the nominal inside diameter ID2 of the second fluid conduit 20. In order for the insertion to fit properly the nominal outside diameter of the neck ODt can be less than the nominal inside diameter of the second fluid conduit ID2 along the insertion distance. Any gap between the outer surface 17 and the inner surface 25 can be filled with sealing material 40 during a sealing, bonding, curing, brazing, or similar process.

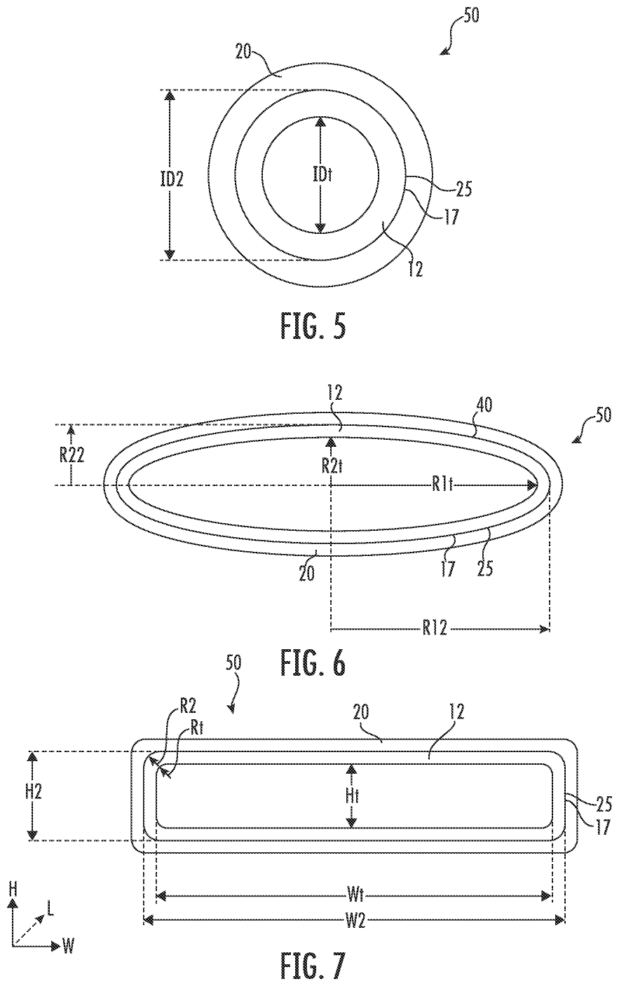

FIGS. 5-7 are schematic illustrations of the transverse cross section of the fluid conduit connection 50 taken at the A-A plane of FIGS. 2-3. The A-A cross sections of FIGS. 2-3 can be taken at any point along the neck 12 where the throat cross-sectional flow area can be determined based on the geometry of the cross section. For example, in FIG. 5 where the first conduit 10 and the second fluid conduit 20 include circular cross-sectional shapes, the throat cross-sectional flow area and the second fluid conduit cross-sectional flow area can be calculated by the formulas:

$$throat cross sectional flow area = π \frac{ {IDt}^{2}}{4}$$

$$second fluid conduit cross sectional flow area = π \frac{ID {2}^{2}}{4}$$

When non-circular cross-sectional shapes are used the throat cross-sectional flow area and second fluid conduit cross-sectional flow area can be calculated according to the geometry of their shape. For example, as shown in FIG. 6, the first conduit 10 and the second fluid conduit 20 can include elliptical cross-sectional shapes. Here the throat cross-sectional flow area can depend on the major radius R1n and the minor radius R2n of the inside surface of the throat, and the second fluid conduit cross-sectional flow area can depend on the major radius R12 and the minor radius R22 of the inside surface 25 of the second fluid conduit 20 as shown in the following flow area formulas.

throat cross sectional flow area=π·R1t·R2t

second fluid conduit cross sectional flow area=π·R12·R22

By way of further example, as shown in FIG. 7, the first conduit 10 and the second fluid conduit 20 can include rounded rectangular cross-sectional shapes. Here the throat cross-sectional flow area can depend on a throat width Wt, a throat height Ht, and a throat corner radius Rt of the inside surface of the throat, and the second fluid conduit cross-sectional flow area can depend on a second fluid conduit width W2 and a second fluid conduit height H2, and a second fluid conduit corner radius R2 of the inside surface 25 of the second fluid conduit 20 as shown in the following flow area formulas.

throat cross sectional flow area=Wt·Ht−4·Rt²+π·Rt²

second fluid conduit cross sectional flow area=W2·H2−4·R2²+π·R2²

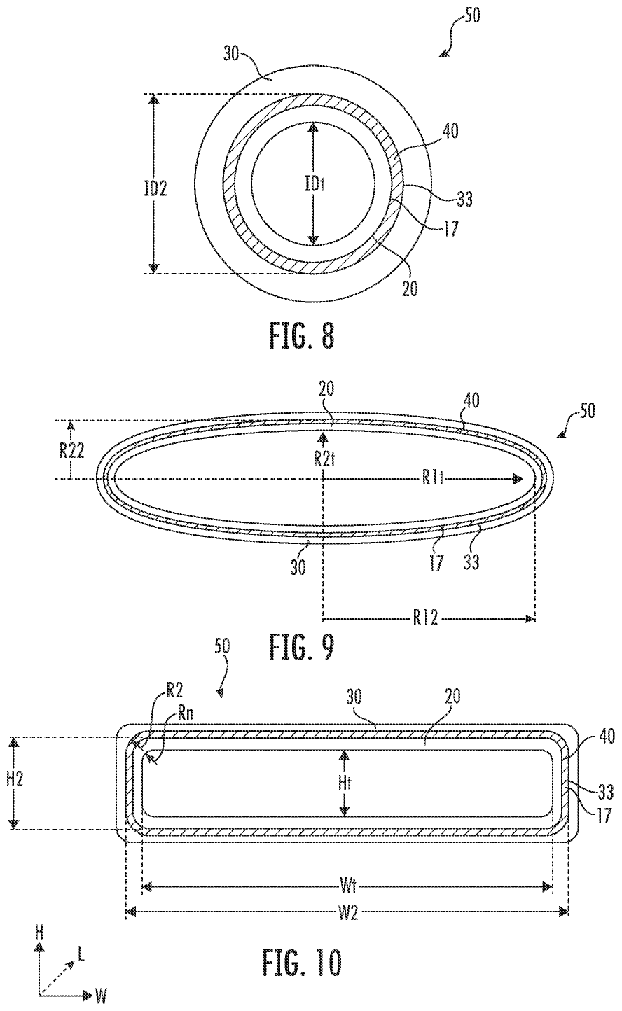

FIGS. 7-9 are schematic illustrations of the A-A cross section of FIG. 3. Here the sealing material 40 can is disposed between the outer surface 27 of the second fluid conduit 20 and the inner surface 33 of the coupling 30. With the coupling 30 disposed along the outside surface 27 of the second fluid conduit 20 the flow area of the throat can be equal to the nominal flow area of the second fluid conduit 20 (e.g., since IDt equals ID2).

When the fluid conduit connection 50 includes a first fluid conduit 10 having a nominal outside diameter of 7 mm or greater and a second fluid conduit 20 having a nominal outside diameter of 7 mm or less, the inventors have found that a ratio of the throat cross sectional flow area divided by the second fluid conduit cross-sectional flow area can significantly influence the overall efficiency of the vapor compression system 100. For example, as the value of this ratio approaches zero the pressure drop of the fluid conduit connection 50 (e.g., at the throat) increases to infinity (e.g., reaching infinite pressure drop when the neck cross sectional flow area is zero). Conversely, as this value approaches unity the wall thickness Tn at the neck of the first fluid conduit 10 approaches values that cannot meet pressure requirements for HVAC plumbing (e.g. burst pressure). Higher system pressure drop can lead to increased compressor work. Without a requisite increase in thermal output the system efficiency decreases. Accordingly, the inventors have found that a range for the ratio of the throat cross-sectional flow area divided by the second fluid conduit cross-sectional flow area of between about 0.1 to about 0.6, or from about 0.12 to about 0.6, or from about 0.25 to about 0.6, or from about 0.35 to about 0.6, or from about 0.4 to about 0.6 or from about 0.5 to about 0.6 can allow for sufficient fluid flow through the fluid conduit connection 50 such that there is a negligible impact on system efficiency and without impacting the overall pressure capability of the fluid conduit connection 50.

The first aluminum alloy of the first fluid conduit 10, the second aluminum alloy of the second fluid conduit 20, the third aluminum alloy of the coupling 30, and the fourth aluminum alloy of the sealing material 40 (e.g., when aluminum brazing is used) can each include a core aluminum alloy. The core aluminum alloy can include aluminum alloys selected from 1000 series, 3000 series, 5000 series, or 6000 series aluminum alloys (as used herein, all alloy numbers and alloy series numbers and individual alloy numbers are as specified and published by The Aluminum Association). For example, core aluminum alloys can include but are not limited to AA3003, AA3004, AA3102, AA3103, or AA5052.

The first aluminum alloy of the first fluid conduit 10, the second aluminum alloy of the second fluid conduit 20, the third aluminum alloy of the coupling 30, and the fourth aluminum alloy of the sealing material 40 (e.g., when aluminum brazing is used) can each include a clad aluminum alloy. The clad aluminum alloy can include aluminum alloys selected from 1000 series, 3000 series, 5000 series, 6000, or 7000 series aluminum alloys. For example, clad aluminum alloys can include but are not limited to AA1100, AA1145, AA3003, AA3102, AA5052, AA7072, AA8005, or AA8011. The alloy of the outer cladding can be less noble, than the alloy of the core. By “less noble”, it is meant that the clad aluminum alloy can be galvanically anodic with respect to the core aluminum alloy, i.e., that the clad aluminum alloy has a lower galvanic potential or a lower electrode potentials than the core aluminum alloy such that the clad aluminum alloy would be anodic with respect to the core aluminum alloy in a galvanic cell. This allows the clad aluminum alloy to provide sacrificial corrosion protection to the core aluminum alloy. In some embodiments, the difference in galvanic potential between the clad aluminum alloy, and the nearest potential of the core aluminum alloy is in a range having a lower end of >0 volts (V), 50 millivolts (mV), or 150 mV, and an upper end of 400 mV, 650 mV, or 900 mV. These range endpoints can be independently combined to form a number of ranges, and each possible combination is hereby expressly disclosed. In some embodiments, the clad aluminum alloy can be provided with reduced nobility by incorporating alloying elements such as zinc or magnesium.

The clad aluminum alloy can be provided with reduced nobility by incorporating alloying elements such as zinc or magnesium. In some embodiments where zinc is present, the zinc can be present in the clad aluminum alloy at a level in a range with a lower end of >0 weight percent (wt. %), 0.8 wt. %, or 4.0 wt. %, zinc and an upper end of 1.3 wt. %, 5.0 wt. %, or 10.0 wt. %. These range endpoints can be independently combined to form a number of ranges, and each possible combination (i.e., 0-1.3 wt. %, 0-5.0 wt. %, 0 10 wt. %, 0.8-1.3 wt. %, 0.8-5.0 wt. %, 0.8-10 wt. %, 4.0-5.0 wt. %, 4.0-10 wt. %, and excluding impossible combinations where a ‘lower’ endpoint would be greater than an ‘upper’ endpoint) is hereby expressly disclosed. In some embodiments where magnesium is present, the magnesium can be present in the clad aluminum alloy at a level in a range with a lower end of >0 wt. %, 0.05 wt. %, 1.0 wt. %, 1.3 wt. % or 2.2 wt. %, and an upper end of 0.4 wt. %, 1.3 wt. %, 2.8 wt. %, or 4.9 wt. %. These range endpoints can be independently combined to form a number of ranges, and each possible combination is hereby expressly disclosed. The clad aluminum alloy can also include one or more alloying elements selected from tin, indium, or gallium. In some embodiments, the selected alloying element(s) can be present in the clad aluminum alloy at a level in a range with a lower end of 0.010 wt. %, 0.016 wt. %, or 0.020 wt. %, and an upper end of 0.020 wt. %, 0.035 wt. %, 0.050 wt. %, or 0.100 wt. %. These range endpoints can be independently combined to produce different possible ranges, each of which is hereby explicitly disclosed (i.e., 0.010-0.020 wt. %, 0.010-0.035 wt. %, 0.010 0.050 wt. %, 0.010-0.100 wt. %, 0.016 0.020 wt. %, 0.016-0.035 wt. %, 0.016 0.050 wt. %, 0.016-0.100 wt. %, 0.020-0.020 wt. %, 0.020-0.035 wt. %, 0.020 0.050 wt. %, 0.020-0.100 wt. %). The clad aluminum alloy can also include one or more other alloying elements for aluminum alloys. In some embodiments, the amount of any individual other alloying element can range from 0-1.5 wt. %. In some embodiments, the total content of any such other alloying elements can range from 0-2.5 wt. %. Examples of such alloying elements include silicon (Si), iron (Fe), manganese (Mn), copper (Cu), titanium (Ti), or chromium (Cr). In some embodiments, the clad aluminum alloy can have a composition consisting of: 4.0-6.0 wt. % zinc or magnesium, 0.01-0.05 wt. % of one or more alloying elements selected from tin, indium, gallium, or combinations thereof, 2.5 wt. % other alloying elements, and the balance aluminum.

Due to the protective nature of subsequent cladding, when a clad alloy is used for the first aluminum alloy of the first fluid conduit 10, the second aluminum alloy of the second fluid conduit 20, the third aluminum alloy of the coupling 30, or the fourth aluminum alloy of the sealing material 40 the corresponding core aluminum alloy can be further modified with additions of iron, silicon and copper to increase strength. The first aluminum alloy of the first fluid conduit 10 and the second aluminum alloy of the second fluid conduit 20, the third aluminum alloy of the coupling 30, and the fourth aluminum alloy of the sealing material 40 (e.g., when aluminum brazing is used) can be the same aluminum alloy. The core aluminum alloy of the first fluid conduit 10, the core aluminum alloy of the second fluid conduit 20, the core aluminum alloy of the coupling 30, and the core aluminum alloy of the sealing material 40 (e.g., when aluminum brazing is used) can be the same core aluminum alloy. The first, second, third, and fourth aluminum alloys can each include the same core aluminum alloy.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fluid conduit connection of a vapor compression system having a cooling capacity of less than or equal to 60,000 Btu/hour comprising:
a first fluid conduit comprising a first aluminum alloy and having first fluid conduit outside hydraulic diameter of greater than or equal to 7 millimeters,
a second fluid conduit comprising a second aluminum alloy, a second fluid conduit cross-sectional flow area, and having a second fluid conduit outside hydraulic diameter of less than or equal to 7 millimeters,
an engagement between the first fluid conduit and the second fluid conduit, and
a sealing material disposed within the engagement serving to mechanically bind and seal the fluid conduit connection, wherein a ratio of a cross sectional flow area of a throat of the fluid conduit connection divided by the second fluid conduit cross-sectional flow area is between 0.1 and 0.6.

2. The fluid conduit connection of claim 1, further comprising a coupling having a first inner surface disposed on a first end and a second inner surface disposed on second end, wherein the first fluid conduit is inserted a first insertion distance of between 1.3 and 12.5 times an outside hydraulic diameter of the second fluid conduit into the first end of the coupling and the second fluid conduit is inserted a second insertion distance of between 1.3 and 12.5 times the outside hydraulic diameter of the second fluid conduit into the second end of the coupling, and wherein the engagement comprises a first inner surface of the coupling and an outer surface of the first fluid conduit and a second inner surface of the coupling and an outer surface of the second fluid conduit.

3. The fluid conduit connection of claim 2, wherein the first insertion distance of the first fluid conduit into the coupling is between 8 and 12 times the outside hydraulic diameter of the second fluid conduit.

4. The fluid conduit connection of claim 2, wherein the second insertion distance of the second fluid conduit into the coupling is between 8 and 12 times the outside hydraulic diameter of the second fluid conduit.

5. The fluid conduit connection of claim 2, wherein a ratio of the first insertion distance divided by an inside hydraulic diameter of the second fluid conduit is between 4.0 and 4.6.

6. The fluid conduit connection of claim 2, wherein a ratio of the second insertion distance divided by an inside hydraulic diameter of the second fluid conduit is between 4.0 and 4.6.

7. The fluid conduit connection of claim 2, wherein the first fluid conduit, the second fluid conduit, and the coupling each comprise a substantially round transverse cross-sectional shape.

8. The fluid conduit connection of claim 1, wherein the first fluid conduit further comprises a neck disposed on one end having a neck length, wherein the second fluid conduit further comprises a belled section disposed on one end, and wherein the neck is inserted an insertion distance of between 1.3 and 12.5 times the outside hydraulic diameter of the second fluid conduit past the belled section, and wherein the engagement comprises an outer surface of the first fluid conduit disposed along a non-necked portion of the first fluid conduit and adjacent to the neck of the first fluid conduit and an inner surface of the second fluid conduit along the belled section.

9. The fluid conduit connection of claim 8, wherein the neck length of the first fluid conduit is between 8 and 12 times the outside hydraulic diameter of the second fluid conduit.

10. The fluid conduit connection of claim 8, wherein a ratio of the neck length divided by an inside hydraulic diameter of the second fluid conduit is between 4.0 and 4.6.

11. The fluid conduit connection of claim 1, wherein the second fluid conduit is an inlet conduit of a an evaporator of the vapor compression system, and wherein the evaporator is a round tube heat exchanger and the second fluid conduit passes through a finned core section of the evaporator.

12. The fluid conduit connection of claim 1, wherein the first fluid conduit is an outlet conduit of an evaporator inlet distributor.

13. The fluid conduit connection of claim 1, wherein the first fluid conduit comprises a conduit formed from a rolling and welded process and the second fluid conduit comprises a conduit formed from an extrusion process.

14. The fluid conduit connection of claim 1, wherein the first fluid conduit and second fluid conduits each comprise a substantially round transverse cross-sectional shape.

15. The fluid conduit connection of claim 1, wherein a ratio of a cross sectional flow area of the throat of the fluid conduit connection divided by the second fluid conduit cross-sectional flow area is between 0.2 and 0.5.

16. A vapor compression system having a cooling capacity of less than or equal to 60,000 Btu/hour comprising:
an evaporator comprising an evaporator inlet conduit,
a fluid distributor comprising a distributor outlet conduit, and
a fluid conduit connection as in claim 1 coupling the evaporator inlet conduit to the distributor outlet conduit.

17. The vapor compression system of claim 16, wherein the evaporator inlet conduit is formed in a rolling and welding process and the distributor outlet conduit is formed in an extrusion process.

18. A method of forming a fluid conduit connection of a vapor compression system having a cooling capacity of less than or equal to 60,000 Btu/hour comprising:
engaging a first fluid conduit and a second fluid conduit to form the fluid conduit connection, and
applying a sealing material between an outer surface of the first fluid conduit and an inner surface of a second fluid conduit or an inner surface of a coupling to mechanically bond and fluidically seal the fluid conduit connection.
